(19) United States
(12) Patent Application Publication
(10) Pub. No.: US 2022/0351622 A1
(43) Pub. Date: Nov. 3, 2022

(54) INTELLIGENT PARK ASSIST SYSTEM TO REDUCE PARKING VIOLATIONS

(71) Applicant: GM GLOBAL TECHNOLOGY OPERATIONS LLC, Detroit, MI (US)

(72) Inventors: Lawrence A. Bush, Shelby Township, MI (US); Prabhjot Kaur, Troy, MI (US); Alexander Telosa, Oak Park, MI (US); Upali P. Mudalige, Oakland Twp., MI (US)

(73) Assignee: GM GLOBAL TECHNOLOGY OPERATIONS LLC, Detroit, MI (US)

(21) Appl. No.: 17/242,905

(22) Filed: Apr. 28, 2021

(51) Int. Cl. G08G 1/14; B60W 30/06; G06N 3/04; G06N 3/08; G07C 5/00; G07B 15/02; G06Q 30/02; G06Q 20/12; G01S 13/931

(52) U.S. Cl. CPC G08G 1/146; B60W 30/06; G06N 3/04; G06N 3/08; G07C 5/008; G07B 15/02; G06Q 30/0284; G06Q 20/127; G01S 13/931; G01S 2013/9314

(57) ABSTRACT

A method for reducing parking violations includes: searching for an empty parking spot in an area surrounding a vehicle; receiving, by a controller of the vehicle, parking restriction information in the area surrounding the vehicle, wherein the controller receives the parking restriction information from sensors of the vehicle; determining, by the controller of the vehicle, that the empty parking spot is invalid; and activating, by the controller of the vehicle, an alarm to alert a vehicle operator of the vehicle that the empty parking spot is invalid.

### INTRODUCTION

The present disclosure relates to vehicle parking and, more particularly, to an intelligent park assist system for reducing parking violations.

### SUMMARY

The present disclosure describes a method for reducing parking violation by integrating information from existing sensors on the vehicle, such as front camera, radar, and Global Positioning System (GPS) information. The vehicle may be equipped with an Advanced Park Assist (APA) system or any other system capable of assisting a vehicle operator in parking the vehicle. The APA assists the vehicle operator in parking the vehicle. In certain vehicles, the APA autonomously (or semi-autonomously) guides the vehicle to an empty parking spot and autonomously (or semi-autonomously) parks the vehicle. When the vehicle is equipped with an APA system or any other system capable of assisting a vehicle operator in parking the vehicle, the surrounding information relevant to parking restrictions, such as parking signs, fire hydrants, etc. that are detected using on-board sensors (e.g., camera, radar, LiDAR) and/or infrastructure-to-vehicle wireless communication may be fed into the APA system during a Stand-By Phase and a Search Phase. When the vehicle is not equipped with the APA system, but has other on-board sensors, those sensors may be used along with the wireless communication and GPS information to detect invalid parking spots, and a warning to the vehicle operator may be issued via the Driver Information Center (DIC). The method may also initiate parking payment transaction through the navigation display or smart phone. The payment transaction may be automatic to void a parking violation.

The present disclosure describes a method for reducing parking violations. In an aspect of the present disclosure, the method includes searching for an empty parking spot in an area surrounding a vehicle; receiving, by a controller of the vehicle, parking restriction information in the area surrounding the vehicle and the empty parking spot, wherein the controller receives the parking restriction information from sensors of the vehicle; determining, by the controller of the vehicle, that the empty parking spot is invalid; and activating, by the controller of the vehicle, an alarm to alert a vehicle operator of the vehicle that the empty parking spot is invalid.

In an aspect of the present disclosure, determining, by the controller of the vehicle, that the empty parking spot is invalid comprises executing an active learning process to determine that the empty parking spot is invalid.

In an aspect of the present disclosure, the active learning process includes: preliminarily determining that the empty parking spot is invalid to generate a preliminary determination that the empty parking spot is invalid; determining a probability that the preliminary determining is incorrect; comparing the probability that the preliminary determining is incorrect with a predetermined threshold to determine whether the probability that the preliminary determination is incorrect is greater than the predetermined threshold; in response to determining that the probability that the preliminary determination is incorrect is greater than the predetermined threshold, querying the vehicle operator to confirm the preliminary determination that the empty parking spot is invalid; receiving a confirmation from the vehicle operator that the empty parking spot is invalid; training a deep neural network using the confirmation from the vehicle operator that the empty parking spot is invalid; and using the trained deep neural network to determine that the empty parking spot is invalid using the parking restriction information received from the sensors.

In an aspect of the present disclosure, the method further includes: determining that the vehicle is not equipped with an advanced park assist system; and in response to determining that the vehicle is not equipped with an advanced park assist system, determining that manual parking has been initiated.

In an aspect of the present disclosure, the sensors of the vehicle include a camera, ground penetrating radar (GPR), a lidar, a radar, and a GPS device.

In an aspect of the present disclosure, the parking restriction information is received from a vehicle-to-infrastructure (V2I) message transmitted by an infrastructure disposed at the area surrounding the vehicle.

In an aspect of the present disclosure, the method further includes: determining that the vehicle is equipped with an advanced park assist (APA) system; in response to determining that the vehicle is equipped with the APA system, determining that the APA system has been initiated. Searching for the empty parking spot in the area surrounding the vehicle includes searching, by the APA system, for the empty parking spot in the area surrounding the vehicle.

In an aspect of the present disclosure, the method further comprising determining, by the controller of the vehicle, that the empty parking spot is valid to identify a valid parking spot; and in response to determining that the empty parking spots is valid, guiding, using the APA system, the vehicle to park in the valid parking spot.

In an aspect of the present disclosure, the method further includes paying a parking payment of a parking meter after the vehicle has parked in the valid parking spot.

In an aspect of the present disclosure, the method further includes monitoring a timer of the parking meter.

In an aspect of the present disclosure, the method further includes:

determining that the timer of the parking meter has expired; and in response to determining that the timer of the parking meter has expired, provide a notification to the vehicle operator that the timer of the parking meter has expired.

The present disclosure also relates to a vehicle system. In an aspect of the present disclosure, the vehicle system includes: a controller; a plurality of sensors in communication with the controller; a communication system in communication with the controller, wherein the communication system is configured to receive a vehicle-to-infrastructure (V2I) message transmitted by an infrastructure disposed at an area surrounding the vehicle system; and a user interface in communication with the controller. The controller is programmed to: search for an empty parking spot in an area surrounding the vehicle system; receive parking restriction information in the area surrounding the vehicle system and the empty parking spot, wherein the controller receives the parking restriction information from sensors of the vehicle system and the V2I messages; determine that the empty parking spot is invalid; and command the user interface to activate an alarm to alert a vehicle operator of the vehicle system that the empty parking spot is invalid.

In an aspect of the present disclosure, the controller is programmed to execute an active learning process to determine that the empty parking spot is invalid. The controller is programmed to execute the active learning process by: preliminarily determining that the empty parking spot is invalid to generate a preliminary determination that the empty parking spot is invalid; determining a probability that the preliminary determining is incorrect; comparing the probability that the preliminary determining is incorrect with a predetermined threshold to determine whether the probability that the preliminary determination is incorrect is greater than the predetermined threshold; in response to determining that the probability that the preliminary determination is incorrect is greater than the predetermined threshold, querying the vehicle operator to confirm the preliminary determination that the empty parking spot is invalid; receiving a confirmation from the vehicle operator that the empty parking spot is invalid; training a deep neural network using the confirmation from the vehicle operator that the empty parking spot is invalid; and using the trained deep neural network to determine that the empty parking spot is invalid using the parking restriction information received from the sensors.

In an aspect of the present disclosure, the sensors include a camera, a GPS device, an ultrasonic sensor, a radar, a lidar, and a ground penetrating radar (GPR).

In an aspect of the present disclosure, the controller is programmed to: determine that the vehicle system is equipped with an advanced park assist (APA) system; in response to determining that the vehicle is equipped with the advanced park assist (APA) system, determine that the APA system has been initiated; and wherein the controller is programmed to search for the parking spot in the area surrounding the vehicle includes searching using the APA system to identify a valid parking spot.

In an aspect of the present disclosure, the controller is programmed to guide, using the APA system, the vehicle system to the valid parking spot.

In an aspect of the present disclosure, the controller is programmed to: determine that the vehicle is not equipped with an advanced park assist system; and in response to determining that the vehicle is not equipped with an advanced park assist system, determine that manual parking has been initiated.

In an aspect of the present disclosure, the controller is programmed to pay a parking payment of a parking meter after the vehicle system has parked in the valid parking spot.

In an aspect of the present disclosure, the controller is programmed to: monitor a timer of the parking meter; determine that the timer of the parking meter has expired; and in response to determining that the timer of the parking meter has expired, provide a notification to the vehicle operator that the timer of the parking meter has expired.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic block diagram of a vehicle.

FIG. 2 is a flowchart of a method for reducing parking violations.

FIG. 3 is a flowchart of a payment process that is part of the method of FIG. 2.

FIG. 4 is a flowchart of an active learning process that is part of the method of FIG. 2.

### DETAILED DESCRIPTION

The following detailed description is merely exemplary in nature and is not intended to limit the application and uses. Furthermore, there is no intention to be bound by expressed or implied theory presented in the preceding technical field, background, brief summary or the following detailed description. As used herein, the term “module” refers to hardware, software, firmware, electronic control component, processing logic, and/or processor device, individually or in a combination thereof, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

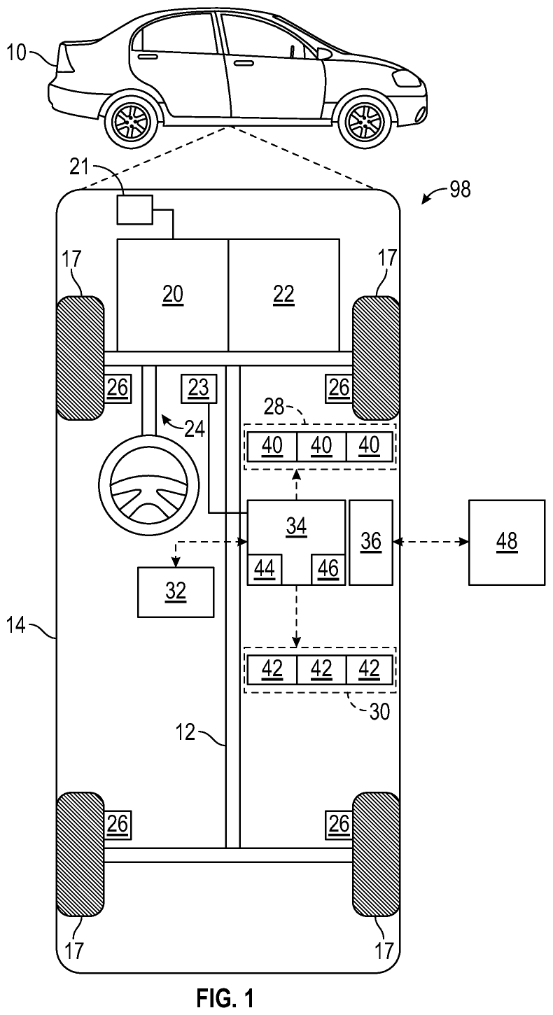

As depicted in FIG. 1, the vehicle 10 generally includes a chassis 12, a body 14, front and rear wheels 17 and may be referred to as the host vehicle or a vehicle system. The body 14 is arranged on the chassis 12 and substantially encloses components of the vehicle 10. The body 14 and the chassis 12 may jointly form a frame. The wheels 17 are each rotationally coupled to the chassis 12 near a respective corner of the body 14.

In various embodiments, the vehicle 10 may be an autonomous vehicle and a control system 98 is incorporated into the vehicle 10. The control system 98 may be simply referred to as the system. The vehicle 10 is, for example, a vehicle that is automatically controlled to carry passengers from one location to another. The vehicle 10 is depicted in the illustrated embodiment as a passenger car, but it should be appreciated that other vehicles including motorcycles, trucks, sport utility vehicles (SUVs), recreational vehicles (RVs), marine vessels, aircraft, etc., can also be used. In an exemplary embodiment, the vehicle 10 is a so-called Level Four or Level Five automation system. A Level Four system indicates “high automation”, referring to the driving mode-specific performance by an automated driving system of aspects of the dynamic driving task, even if a human driver does not respond appropriately to a request to intervene. A Level Five system indicates “full automation”, referring to the full-time performance by an automated driving system of aspects of the dynamic driving task under a number of roadway and environmental conditions that can be managed by a human driver.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an electric machine such as a traction motor and/or a fuel cell propulsion system. The vehicle 10 further includes a battery (or battery pack) 21 electrically connected to the propulsion system 20. Accordingly, the battery 21 is configured to store electrical energy and to provide electrical energy to the propulsion system 20. Additionally, the propulsion system 20 may include an internal combustion engine. The transmission system 22 is configured to transmit power from the propulsion system 20 to the vehicle wheels 17 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 17. The brake system 26 may, in various embodiments, include friction brakes, brake by wire, a regenerative braking system such as an electric machine, and/or other appropriate braking systems. The steering system 24 influences a position of the vehicle wheels 17. While depicted as including a steering wheel for illustrative purposes, in some embodiments contemplated within the scope of the present disclosure, the steering system 24 may not include a steering wheel.

The sensor system 24 includes one or more sensors 40 (i.e., sensing devices) that sense observable conditions of the exterior environment and/or the interior environment of the vehicle 10. The sensors 40 are in communication with the controller 34 and may include, but are not limited to, one or more radars, one or more light detection and ranging (lidar) sensors, one or more ground penetrating radar (GPR) sensors, one or more global positioning systems (GPS) devices, one or more cameras (e.g., optical cameras and/or thermal cameras, such as a rear camera and/or a front camera), speed sensor, steering angle sensor, ultrasonic sensors, one or more inertial measurement units (IMUs) and/or other sensors. Each sensor 40 is configured to detect one or more parking restriction information or data in the area surrounding the vehicle 10. For example, one or more sensors 40 may detect peak period signs, not stopping/no standing sign, street cleaning signs, no stop at specific time sign, one or more fire hydrants, no stop/bus zone signs, one or more fire lanes, one or more handicap zones, no parking—sidewalk sign, boot citation area, one or more preferential parking signs, one or more permit parking signs, one or more parking restriction signs, one or more parking restriction lines or markings.

The actuator system 30 includes one or more actuator devices 42 that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The sensor system 28 includes one or more Global Positioning System (GPS) transceiver configured to detect and monitor the route data (i.e., route information). The GPS device is configured to communicate with a GPS to locate the position of the vehicle 10 in the globe. The GPS device is in electronic communication with the controller 34. Because the sensor system 28 provides data to the controller 34, the sensor system 28 and its sensors 40 are considered sources of information (or simply sources).

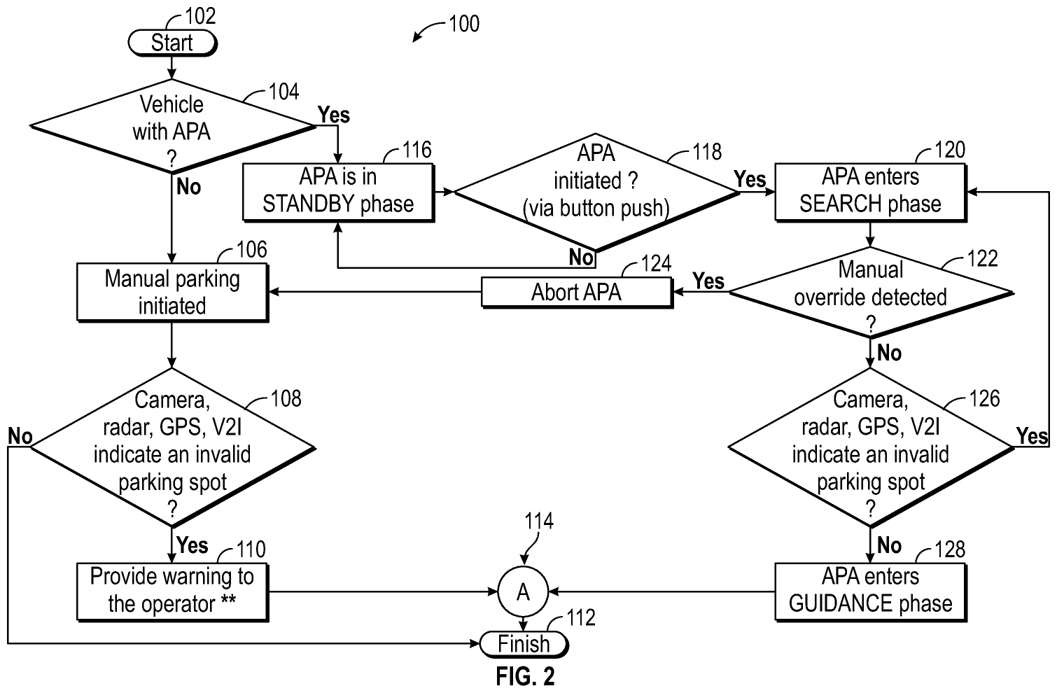

The data storage device 32 stores data for use in automatically controlling the vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. The data storage device 32 may be part of the controller 34, separate from the controller 34, or part of the controller 34 and part of a separate system.

The controller 34 includes at least one processor 44 and a non-transitory computer readable storage device or media 46. The processor 44 can be a custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using a number of known memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although a single controller 34 is shown in FIG. 1, embodiments of the vehicle 10 may include a number of controllers 34 that communicate over a suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the control system 98. The vehicle 10 includes a user interface 23, which may be a touchscreen in the dashboard. The user interface 23 may be configured as an alarm, such as a speaker to provide a sound, a haptic feedback in a vehicle seat or other object, a visual display, or other device suitable to provide a notification to the vehicle operator of the vehicle 10. The user interface 23 is in electronic communication with the controller 34 and is configured to receive inputs by a user (e.g., vehicle operator). Accordingly, the controller 34 is configured to receive inputs from the user via the user interface 23. The user interface 23 includes a display configured to display information to the user (e.g., vehicle operator or passenger) and may include one or more speakers to provide an auditable notification to the vehicle operator. The user interface 23 may be a driver information center (DIC) capable of providing information to the vehicle operator of the vehicle 10.

The communication system 36 is in communication with the controller 34 and is configured to wirelessly communicate information to and from other entities 48, such as but not limited to, other vehicles (“V2V” communication), infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. Accordingly, the communication system 36 may include one or more antennas and/or transceivers for receiving and/or transmitting signals, such as cooperative sensing messages (CSMs). The communication system 36 is configured to wirelessly communicate information between the vehicle 10 and another vehicle. Further, the communication system 36 is configured to wirelessly communication information between the vehicle 10 and infrastructure, such as a parking meter. Accordingly, the vehicle 10 may use V2I communications to receive parking restriction information or data from an infrastructure, such as a parking meter.

FIG. 2 is a flowchart for a method 100 for minimizing parking violations, which may be executed by the controller 34. The method 100 begins at block 102. Then, the method 100 proceeds to block 104. At block 104, the controller 34 determines whether the vehicle 10 is equipped with an advance park assist (APA) system. If the vehicle 10 is not equipped with an APA system, then the method 100 proceeds to block 106.

At block 106, the controller 34 determines whether manual parking has been initiated. To do so, the controller 34 receives inputs from the sensors 40, such as the speed sensors, steering angle sensors, among others. The controller 34 then determines whether the manual parking has been initiated using the inputs from the sensors 40. At block 106, the vehicle operator of the vehicle 10 is searching an empty parking spot in the area surrounding the vehicle 10. To do so, the vehicle 10 may use sensors 40, such as cameras and/or ultrasonic sensors. The controller 34 then identifies an empty parking spot using the inputs from the sensors 40. Further, at block 106, the vehicle operator of the vehicle 10 has identified an empty parking spot but the vehicle operator does not necessarily know whether the identified empty parking spots is valid or invalid. The method 100 then proceeds to block 108.

At block 108, the controller 34 receives parking restriction information (or parking restriction data) in the area surrounding the vehicle 10 and in the area surrounding the identified empty parking spot from the sensors 40 and/or V2I communications from an infrastructure. As mentioned above, the sensor 40 may include one or more cameras (front and/or rear cameras), one or more radars, one or more lidars, one or more ultrasonic sensors, one or more GPS devices, among others. Using this parking restriction information, the controller 34 determines whether the identified empty spot is valid or invalid. A parking spot is invalid if it violates a law. Block 108 may entail an active learning process as described below. If the identified, empty parking spot is invalid, then the method 100 proceeds to block 110. Otherwise, if the identified, empty parking spot is valid, the method 100 proceed to block 112. At block 112, the method 100 ends.

At block 110, the controller 34 commands the user interface 23 to provide a notification or a warning to the vehicle operator of the vehicle 10, indicating that the identified empty parking spot is invalid. To do so, the controller 34 commands an alarm (through the user interface 23) to activate to alert a vehicle operator of the vehicle 10 that the identified empty parking spot is invalid. As discussed above, this alarm may be in the form of an audible sound, a haptic feedback in a vehicle seat or other object, information displaced in a visual display, or other notification or warning to the vehicle operator of the vehicle 10. The notification may also include a notification to the cell phone of the vehicle operator of the vehicle 10. After block 110, the method 100 proceeds to block 114, which is described in detail below.

Returning to block 104, if the vehicle 10 is equipped with the APA system, then the method 100 proceeds to block 116. At block 116, the APA system is in the standby phase or mode. Then, the method 100 proceeds to block 118. At block 118, the APA system is initiated. To do so, the vehicle operator of the vehicle 10 may, for example, push a button on the user interface 23 to initiate the APA system. The APA system, however, may be initiated other ways. If the APA system is not initiated, the method 100 returns to block 116. However, if the APA system is initiated, then the method 100 proceeds to block 120.

At block 120, the APA system, using the controller 34, enter the search phase. In the search phase, the APA system searches for an empty parking spot in the area surrounding the vehicle 10. To do so, the APA system may use the sensors 40 of the vehicle 10, such as cameras and/or ultrasonic sensors. Then, the method 100 proceeds to block 122.

At block 122, the controller 34 determines whether there is a manual override. The manual override may be an input from the vehicle operator through the user interface 23. If a manual override is detected, then the method 100 proceeds to block 124. At block 124, the APA system and associated maneuvers is aborted. Then, the method 100 proceeds to block 106.

If the manual override is not detected at block 122, then the method 100 proceeds to block 126. At block 126, the controller 34 receives parking restriction information (or parking restriction data) in the area surrounding the vehicle 10 (and in the area surrounding the identified empty parking spot) from the sensors 40 and/or V2I communications from an infrastructure. As mentioned above, the sensor 40 may include one or more cameras (front and/or rear cameras), one or more radars, one or more lidars, one or more ultrasonic sensors, one or more GPS devices, among others. Using this parking restriction information, the controller 34 determines whether the identified empty parking spot is valid or invalid. A parking spot is invalid if it violates a law or regulation. A parking spot is invalid if it violates a law or regulation. Block 126 may entail an active learning process as described below. If the identified parking spot is invalid, then the method 100 returns to block 120. Otherwise, if the identified parking spot is valid, the method 100 proceed to block 128.

At block 128, the APA system enters the guidance phase. In the guidance phase, the APA system automatically guides the vehicle 10 to the valid parking spot. After block 128, then method 100 proceeds to block 114, which is a parking payment process. After block 114, the method 100 ends at block 112.

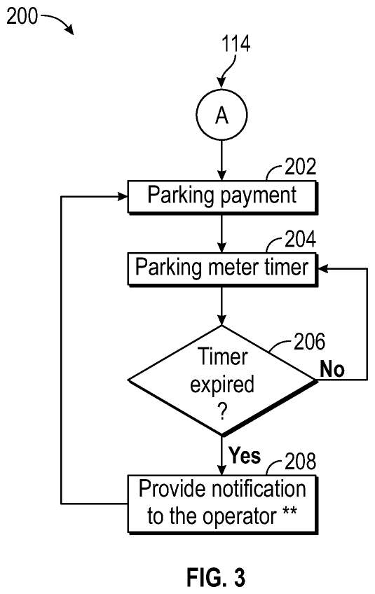

FIG. 3 is a flowchart of a parking payment process 200, which begins at block 114. Then, the parking payment process 200 continuous to block 202. At block 202, the vehicle operator pays for parking (if necessary) once the vehicle 10 is parked. To do so, the vehicle operator of the vehicle 10 may manually pay for the parking by interacting with a parking meter with cash, credit cards, debits cards, among others. Alternatively, the vehicle operator may pay with an app on his or her phone. Also, the vehicle operator may pay for the parking spot using the user interface 23 and sending a V2I communication. Further, the parking payment may occur automatically in response to the V2I communication received by the controller 34 of the vehicle. The vehicle operator may pay to park at this parking spot for a set amount of time (i.e., the paid amount of time). Once the parking payment is made, the parking payment process 200 proceeds to block 204.

At block 204, the parking meter timer starts. Then, the parking payment process 200 proceeds to block 206 to determine the amount of time that has lapsed since the vehicle operator paid for the parking. Then, the parking payment process 200 proceeds to block 206.

At block 206, the controller 34 of the vehicle 10 and/or the cell phone of the vehicle user receives a message from the parking meter, via for example V2I communications, about whether the park meter timer has expired. The park meter timer expires when the vehicle 10 has parked in the parking spot for the paid amount of time. If the park meter timer has not expired, then the parking payment process 200 returns to block 204. If the park meter timer has expired, then the parking payment process 200 continues to block 208.

At block 208, the controller 34 provides a notification to the vehicle operator that the timer of the parking meter has expired. To do so, the notification may be sent to the cell phone of the vehicle operator if the cell phone is linked to the vehicle 10. Also, at block 208, the payment may occurr automatically if the time left of the park meter timer is less than a predetermined amount of time to avoid a parking violation.

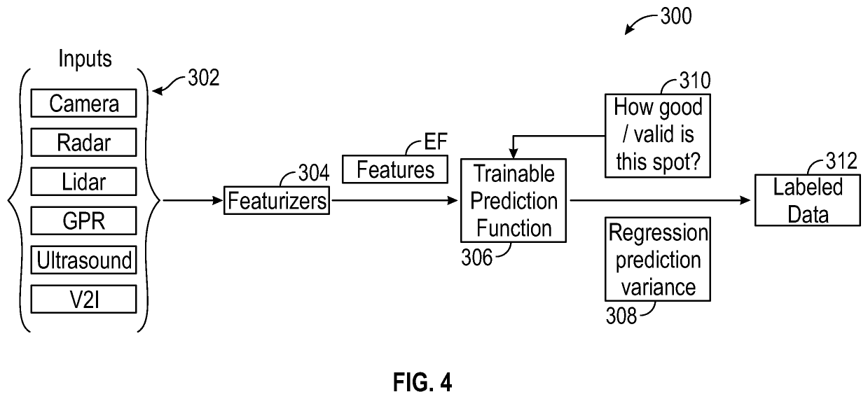

FIG. 4 is a flowchart of an active learning process 300. The controller 34 execute the active learning process 300 to determine that the identified empty parking spot is invalid. The active learning process 300 begins at block 302. At block 302, the controller 34 receives inputs (i.e., the parking restriction information) from the sensors 40 and V2I messages. As discussed above, the sensors 40 may include, for example, cameras, radars, lidar, GPR sensors, ultrasound sensors, GPS devices, among others. The active learning process 300 then proceeds to block 304.

At block 304, the controller 34 uses featurizers to process the inputs received form the sensors 40 and the V2I communications. The featurizers extract relevant features from inputs, such as images. For example, a featurizer may extract features from image (captured by a camera) to classify an object in the image as a fire hydrant. The extracted features EF. Then, the active learning process 300 proceeds to block 306.

At block 306, the features extracted by the featurizers are fed into a trainable prediction function, such as a deep neural network. The trainable prediction function then determines whether the identified empty parking spot is invalid using the parking restriction information received from the sensors 40 and/or the V2I communications. This determination may be a preliminary determination that the identified empty parking spot is invalid. Then, the method 300 proceeds to block 308.

At block 308, the controller 34 determines the probability that this preliminary determination that the identified empty parking spot is invalid is incorrect. To do so, the controller 34 may calculate a regression prediction variance of the preliminary determination the identified empty parking spot is invalid. The “regression prediction variance’ is the error involved in making a prediction using a regression model. The regression prediction variance therefore measures how far observed values differ from the average predicted values (i.e., their different from the predicted value mean). Then, the active learning process 300 proceeds to block 310.

At block 310, the controller 34 compares the probability that the preliminary determination is incorrect with a predetermined threshold to determine whether the probability that the preliminary determination is incorrect is greater than the predetermined threshold. In response to determining that the probability that the preliminary determination is incorrect is greater than the predetermined threshold, the controller 34 commands the user interface 23 to query the vehicle operator to confirm that the preliminary determination that the identified empty parking spot is invalid. In an example, the controller 34 determines whether the regression prediction variance is greater than a predetermined threshold. If the regression prediction variance is greater than the predetermined threshold, then the controller 34 commands the user interface 23 to query the vehicle operator to confirm that the preliminary determination that the identified empty parking spot is invalid. To confirm, the vehicle 10 may push a button in the user interface 23 at block 310. The controller 34 then receives the confirmation that the identified empty parking spot is invalid from the vehicle operator. The vehicle operator may alternatively determine that the preliminary determination is incorrect. Regardless of the input from the vehicle operator, this input is fed into the trainable prediction function to train the deep neural network. In other words, the controller 34 trains the deep neural networking using the answer from the vehicle operator (e.g., the confirmation that the identified empty parking spot is invalid). The trained deep neural network is then used to determine that the identified empty parking spot is invalid using the parking restriction information received from the sensors 40 and/or the V2I communications. Then, the active learning process 300 continues to block 312.

At block 312, the controller 34 outputs labeled data as invalid parking spot or a valid parking spot based on determination of the trainable prediction function (e.g., deep neural network).

The detailed description and the drawings or figures are a supportive description of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for reducing parking violations, comprising:
searching for an empty parking spot in an area surrounding a vehicle;
receiving, by a controller of the vehicle, parking restriction information in the area surrounding the vehicle and the empty parking spot, wherein the controller receives the parking restriction information from sensors of the vehicle;
determining, by the controller of the vehicle, that the empty parking spot is invalid; and
activating, by the controller of the vehicle, an alarm to alert a vehicle operator of the vehicle that the empty parking spot is invalid.

2. The method of claim 1, wherein determining, by the controller of the vehicle, that the empty parking spot is invalid comprises executing an active learning process to determine that the empty parking spot is invalid.

3. The method of claim 2, wherein the active learning process includes:
preliminarily determining that the empty parking spot is invalid to generate a preliminary determination that the empty parking spot is invalid;
determining a probability that the preliminary determination is incorrect;
comparing the probability that the preliminary determination is incorrect with a predetermined threshold to determine whether the probability that the preliminary determination is incorrect is greater than the predetermined threshold;
in response to determining that the probability that the preliminary determination is incorrect is greater than the predetermined threshold, querying the vehicle operator to confirm the preliminary determination that the empty parking spot is invalid;
receiving a confirmation from the vehicle operator that the empty parking spot is invalid;
training a deep neural network using the confirmation from the vehicle operator that the empty parking spot is invalid; and
using the trained deep neural network to determine that the empty parking spot is invalid using the parking restriction information received from the sensors.

4. The method of claim 1, further comprising:
determining that the vehicle is not equipped with an advanced park assist system; and
in response to determining that the vehicle is not equipped with an advanced park assist system, determining that manual parking has been initiated.

5. The method of claim 4, wherein the sensors of the vehicle include a camera, ground penetrating radar (GPR), a lidar, a radar, and a GPS device.

6. The method of claim 5, wherein the parking restriction information is received from a vehicle-to-infrastructure (V2I) message transmitted by an infrastructure disposed at the area surrounding the vehicle.

7. The method of claim 1, further comprising:
determining that the vehicle is equipped with an advanced park assist (APA) system;
in response to determining that the vehicle is equipped with the APA system, determining that the APA system has been initiated; and
wherein searching for the parking spot in the area surrounding the vehicle includes searching, by the APA system, for the empty parking spot in the area surrounding the vehicle.

8. The method of claim 7, further comprising determining, by the controller of the vehicle, that the empty parking spot is valid to identify a valid parking spot; and
in response to determining that the empty parking spots is valid, guiding, using the APA system, the vehicle to park in the valid parking spot.

9. The method of claim 8, further comprising paying a parking payment of a parking meter after the vehicle has parked in the valid parking spot.

10. The method of claim 9, further comprising monitoring a timer of the parking meter.

11. The method of claim 10, further comprising:
determining that the timer of the parking meter has expired; and
in response to determining that the timer of the parking meter has expired, provide a notification to the vehicle operator that the timer of the parking meter has expired.

12. A vehicle system, comprising:
a controller;
a plurality of sensors in communication with the controller;
a communication system in communication with the controller, wherein the communication system is configured to receive a vehicle-to-infrastructure (V2I) message transmitted by an infrastructure disposed at an area surrounding the vehicle system;
a user interface in communication with the controller;
wherein the controller is programmed to:
search for an empty parking spot in an area surrounding the vehicle system;
receive parking restriction information in the area surrounding the vehicle system and the empty parking spot, wherein the controller receives the parking restriction information from sensors of the vehicle system and the V2I messages;
determine that the empty parking spot is invalid; and
command the user interface to activate an alarm to alert a vehicle operator of the vehicle system that the empty parking spot is invalid.

13. The vehicle system of claim 12, wherein the controller is programmed to execute an active learning process to determine that the empty parking spot is invalid.

14. The vehicle system of claim 13, wherein the controller is programmed to execute the active learning process by:
preliminarily determining that the empty parking spot is invalid to generate a preliminary determination that the empty parking spot is invalid;
determining a probability that the preliminary determining is incorrect;
comparing the probability that the preliminary determining is incorrect with a predetermined threshold to determine whether the probability that the preliminary determination is incorrect is greater than the predetermined threshold;
in response to determining that the probability that the preliminary determination is incorrect is greater than the predetermined threshold, querying the vehicle operator to confirm the preliminary determination that the empty parking spot is invalid;
receiving a confirmation from the vehicle operator that the empty parking spot is invalid;
training a deep neural network using the confirmation from the vehicle operator that the empty parking spot is invalid; and
using the trained deep neural network to determine that the empty parking spot is invalid using the parking restriction information received from the sensors.

15. The vehicle system of claim 12, wherein the sensors include a camera, a GPS device, an ultrasonic sensor, a radar, a lidar, and a ground penetrating radar (GPR).

16. The vehicle system of claim 12, wherein the controller is programmed to:
determine that the vehicle system is equipped with an advanced park assist (APA) system;
in response to determining that the vehicle is equipped with the advanced park assist (APA) system, determine that the APA system has been initiated; and
wherein the controller is programmed to search for the empty parking spot in the area surrounding the vehicle includes searching, using the APA system, to identify a valid parking spot.

17. The vehicle system of claim 16, wherein the controller is programmed to guide, using the APA system, the vehicle system to the valid parking spot.

18. The vehicle system of claim 12, wherein the controller is programmed to:
Determine that the vehicle is not equipped with an advanced park assist system; and
in response to determining that the vehicle is not equipped with an advanced park assist system, determine that manual parking has been initiated.

19. The vehicle system of claim 18, wherein the controller is programmed to pay a parking payment of a parking meter after the vehicle system has parked in the valid parking spot.

20. The vehicle system of claim 19, wherein the controller is programmed to:
monitor a timer of the parking meter;
determine that the timer of the parking meter has expired; and
in response to determining that the timer of the parking meter has expired, provide a notification to the vehicle operator that the timer of the parking meter has expired.
